(19) United States
(12) Patent Application Publication
(10) Pub. No.: US 2026/0228702 A1
(43) Pub. Date: Aug. 6, 2026

(54) SYSTEM AND METHOD USING SENSOR DATA TO DETERMINE LOCATION COORDINATES

(71) Applicant: Walmart Apollo, LLC, Bentonville, AR (US)

(72) Inventor: Navin Naidu, Sunnyvale, CA (US)

(21) Appl. No.: 19/042,108

(22) Filed: Jan. 31, 2025

(51) Int. Cl. G06Q 10/20; H04W 4/021; H04W 4/024

(52) U.S. Cl. CPC G06Q 10/20; H04W 4/021; H04W 4/024

(57) ABSTRACT

Sensor data from a sensor that is associated with a mobile device is obtained with respect to an asset of an indoor facility. Using the sensor data, location coordinates of the mobile device within the indoor facility, the coordinates being in a global frame of reference. Identification information associated with the asset is also received. The coordinates from the global frame of reference are converted to a frame of reference of the indoor facility. The converted coordinates and the identification information are associated with a work order associated with the asset. An asset map is updated with the converted coordinates of the asset and represents a digital twin of the indoor facility.

### TECHNICAL FIELD

This disclosure relates generally to assets in a facility, and more specifically to determining locations of assets.

### BACKGROUND

To improve the shopping experience for customers, retail facilities should be operated at maximum efficiency. Operating at maximum efficiency requires that items are stocked correctly and all assets within the store (e.g., refrigerators, and balers) are optimally functioning with servicers (e.g., technicians) being responsible for servicing and repairing the assets. To service the assets, the assets need to be first located by the servicer. If the information concerning asset locations is not readily available or confusing then the servicers may waste time and resources locating these assets.

### BRIEF DESCRIPTION OF DRAWINGS

Disclosed herein are embodiments of systems, apparatuses and methods pertaining to determining and tracking the locations of assets. This description includes drawings, wherein:

FIG. 1 is a block diagram of a system in accordance with some embodiments.

FIG. 2 is flowchart of an approach in accordance with several embodiments.

FIG. 3 is a block diagram of a computer medium in accordance with some embodiments.

FIG. 4 is a flowchart of an approach in accordance with several embodiments.

FIG. 5 is flowchart of an approach in accordance with some embodiments.

FIG. 6 is block diagram of a work order in accordance with several embodiments.

FIG. 7 is a diagram of a displayable store map in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein that are useful to track asset locations for assets deployed, for example, in retail stores, warehouses, distribution centers, or other indoor facilities. Some of the asset locations are permanent locations and the asset will not typically move from the location. For example, once deployed a refrigerator unit will not typically be moved. In other examples, the asset may be moveable such as a product display unit and the location of this type of asset may change over time. Advantegously, the approaches described herein determine asset locations within sub-meter accuracy. This determined location can then be used by servicers to find and reach the asset without contacting or involving employees of the store or using other store resources.

One area of facilities management is asset repair and one of the deficiencies that has been observed in previous approaches involves managing servicer or technician walk-time. With thousands of servicers or technicians servicing many stores, it has been found that technicians for large stores are spending too much time walking through the store trying to find the assets that they are going to service.

One of the issues with reducing technician walk-time is the ability to understand where these assets are located within the store. In the approaches provided herein, asset location information is determined and provided as part of the work order creation, instead of the technician trying to contact the store employee who created the work order to help them navigate to the asset location.

Generally speaking, the approaches provided herein create and maintain a dynamically changing location database with asset (and in some cases, product) locations. The dynamically changing database can be utilized directly (or using various types of computer applications) to allow servicers to quickly understand the layout of the store and allow different functions or actions to be performed by the servicers. In aspects, the database is created by “bootstrapping” the asset location within the store as part of the work order creation process. That is, when the work order is created the location of the asset is also determined and incorporated into the dynamically changing location database along with the work order. Consequently, this asset location may be immediately available for use by the servicer to assist them in locating the asset quickly and efficiently.

In one specific example, when a work order is created, the location of an asset (e.g., machinery) is associated with the work order. A store employee physically goes to the asset location and scans information from the asset (e.g., scans a QR code) with their mobile device (e.g., smartphone). The location of the asset can then be determined (e.g., using a location determination system or technology (such as magnetic GPS (mGPS) technology) where the location resolution is one meter or less). The location that has been determined is converted into the coordinate system or frame of reference of the store and, in examples, includes x, y, and z coordinates (bringing spatial awareness and context to the asset location). The location can be stored in a dynamically changeable location database, which may be a database in the cloud. In other examples, the employee scanning the asset can examine their location on a map displayed on their smartphone and can manually adjust this location if the location seems incorrect. It will be appreciated that a robot or other automated device rather than a store employee can also be sent to the asset and perform the functions mentioned above.

Advantageously and in some aspects, store employees do not have to manually capture the location of an asset. The “bootstrapping” of assets can happen as a background process. All actions in apps executed by the employee, including creating the work order, are automatically captured or occur in the background. Using location determination approaches (e.g., mGPS technology), the current location of the mobile device carried by the employee is known. This means the location of any employee action (e.g., creating the work order) is also known. By understanding the context and metadata of the action (e.g., understanding for which asset the work order is being created), the location of the event is attached to the event and this information is “bootstrapped” in the location database.

In another example, stack bases (e.g., tables or other structures) are located in the wide aisles of stores and used to store products. It is hard to track their location and the products they hold. A store employee as part of, for example, moving the stack base, could indicate the location of the stack base (e.g., by dropping a pin for the location of the stack bases on a screen of their smartphone, by scanning a QR code associated with the stack base, or taking some other action). As with other examples, a mGPS system can also be used to determine the smartphone location, and this converted into store coordinates, which are stored in the dynamic location database. As mentioned, the location may be stored at a database in the cloud.

Stack bases typically are moved frequently (e.g., along the aisles in the store) and this makes it difficult to understand the exact location of the stack base within the store. However, with the present approaches, an event (e.g., work order creation or the creation/filling out/submission of some other electronic form to mention two examples) is generated every time a stack base is moved and the current location of device is attached to this event. Event ingestion and attaching location to the event happens in the background and the store employee does not have to take any additional action. By doing this, spatial awareness of store operations is achieved and intelligence derived to build a dynamic digital twin of the store (i.e., a virtual model of the physical store that can be used for e.g., monitoring, simulation, etc.).

The location database can then be accessed and used by other applications. A store map with the location of the database can be created and presented to the servicer. For example, when a technician visits the store to repair an asset, they can access (or be supplied with) the store map showing the asset and directions to the asset. This map can be rendered on a mobile device if the servicer. The location database dynamically changes over time as asset locations change and as mentioned, this database can be used by a variety of different applications for various purposes including not only servicing assets, but also tracking products associated with these assets.

In many of these embodiments, a system comprises a database, and a mobile device. The mobile device comprises a processing resource communicatively coupled to the database via an electronic network, a sensor coupled to the processing resource, and a machine readable medium coupled to the processing resource. The machine readable medium stores instructions that, where executed by the processing resource and when the mobile device has been brought to an immediate vicinity of an asset of an indoor facility, cause the processing resource to: obtain sensor data from the sensor, determine, using the sensor data, location coordinates of the mobile device within the indoor facility, the coordinates being in a global frame of reference, receive identification information associated with the asset, convert the coordinates from the global frame of reference to a frame of reference of the indoor facility, and associate the converted coordinates and the associated identification information with a work order associated with the asset, the work order stored in the database. The asset map in the database for the indoor facility is updated with the converted coordinates of the asset, the asset map representing a digital twin of the indoor facility. Subsequently, the asset map is accessed and used by a servicer to locate and navigate to the asset without involvement of employees or resources of the indoor facility allowing an adjustment or a servicing of the asset by the servicer to occur.

In aspects, the identification information is obtained by scanning a code on the asset. In other aspects, the identification information comprises a name of the asset.

In some examples, the asset comprises a store appliance or a store fixture. Other examples of assets are possible.

In other examples, the mobile device determines the coordinates by sensing a magnetic location of the mobile device using the sensor. In some other examples, the mobile device is brought to the asset by a store employee. In other examples, a robot may be used in place of the employee and mobile device.

In other aspects, the converted coordinates of the asset are dynamically updated over time based upon the creation of subsequent work orders. For example, some assets in a store are movable and as subsequent work orders involving these assets are created, then the locations of the asset may change.

In others of these embodiments, an approach for determining and using asset locations is described. Sensor data is obtained from a sensor that is associated with a mobile device that is positioned in an immediate vicinity of an asset of an indoor facility. Using the sensor data, location coordinates of the mobile device are determined within the indoor facility. The coordinates are in a global frame of reference. Identification information associated with the asset is received. The coordinates are converted from the global frame of reference to a frame of reference of the indoor facility. The converted coordinates and the associated identification information are associated with a work order associated with the asset, the work order stored in a database. An asset map in the database for the indoor facility is updated with the converted coordinates of the asset, the asset map representing a digital twin of the indoor facility. Subsequently, the asset map is accessed and used by a servicer to locate and navigate to the asset without involvement of employees or resources of the indoor facility allowing an adjustment or a servicing of the asset by the servicer to occur.

In others of these embodiments, a non-transitory machine readable medium stores instructions that, when executed, cause a processing resource to perform various actions or functions. When a mobile device is brought to an immediate vicinity of an asset of an indoor facility, the instructions obtain sensor data from the sensor associated with the mobile device. The instructions determine, using the sensor data, location coordinates of the mobile device within the indoor facility, the coordinates being in a global frame of reference. The instructions further receive identification information associated with the asset, and convert the coordinates from the global frame of reference to a frame of reference of the indoor facility. The instructions associate the converted coordinates and the associated identification information with a work order associated with the asset, the work order stored in a database, and update an asset map in the database for the indoor facility with the converted coordinates of the asset, the asset map representing a digital twin of the indoor facility. Subsequently, the asset map is accessed and used by a servicer to locate and navigate to the asset without involvement of employees or resources of the indoor facility allowing an adjustment or a servicing of the asset by the servicer to occur.

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in but not limited to at least one embodiment. Thus, appearances of the phrases “in one embodiment,” “in an embodiment,” “in some embodiments”, “in some implementations”, and similar language throughout this specification may, but do not necessarily, all refer to the same embodiment.

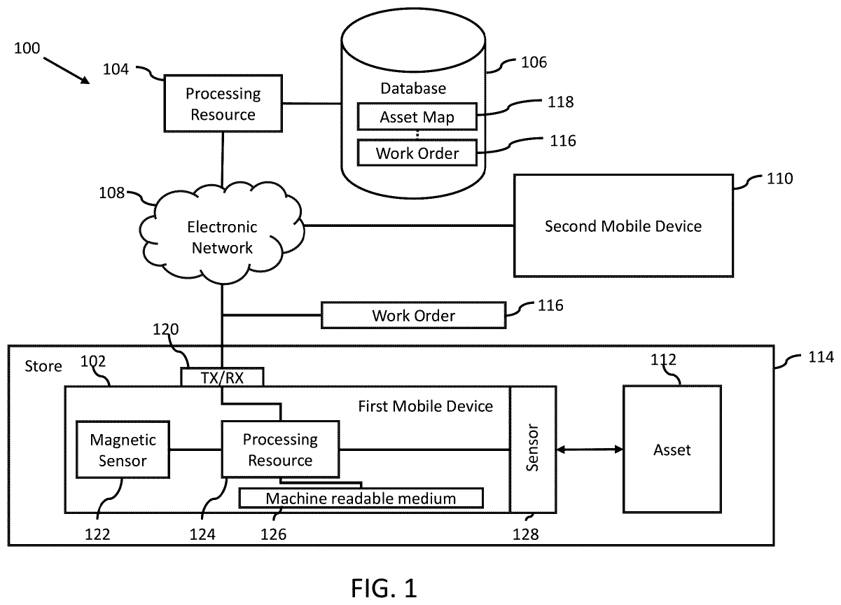

Referring now to FIG. 1, one example of a system 100 for determining, tracking, and using asset locations is described. The system 100 includes a first mobile device 102 (that is operated within an indoor facility such as a retail store 114), a processing resource 104, a database 106, an electronic network 108, and a second mobile device 110. An asset 112 is deployed at the retail store 114. The first mobile device 102 includes a transmitter/receiver (TX/RX) 120, a magnetic sensor 122, a processing resource 124, machine readable media 126, and a sensor 128. A work order 116 is sent from the mobile device 102 to the processing resource 104 and stored in the database 106. The database 106 also stores an asset map 118.

The first mobile device 102 is any type of mobile electronic communication device. For example, the first mobile device 102 may be a smart phone, personal computer, or laptop to mention a few examples. Further details about the mobile device 102 are described elsewhere herein.

The retail store 114 is any type of indoor facility such as a building or other structure that offers or stores products to be offered to customers. The retail store 114 may include shelves, display units, and stack bases to mention a few examples of structures that are used to present products to customers. In other examples, the retail store 114 also includes appliances (e.g., refrigerators, coolers, and heated display units to mention a few examples) to present perishable products to customers. The retail store 114 may also include other areas such as backrooms (to store products before products are brought to customer accessible areas), other storage rooms, checkout areas, and customer service areas to mention a few examples. In other aspects, the retail store 114 may be a warehouse, distribution center, or other similar arrangements or structures.

The processing resource 104 may be configured to execute instructions stored in a machine (or computer)-readable storage memory (e.g., a non-transitory, computer-readable storage medium). Consequently, the processing resource 104 may include a machine readable medium to store electronic instructions as well as a control circuit or controller to execute these instructions.

In this context, the terms control circuit and controller refer broadly to any microcontroller, computer, or processor-based device with processor, memory, machine readable medium, and/or programmable input/output peripherals, which is generally designed to govern the operation of other components and devices. It is further understood to include common accompanying accessory devices, including memory, a machine readable medium, transceivers for communication with other components and devices to mention a few examples. These architectural options are well known and understood in the art and require no further description here.

The processing resource 104 may be configured (for example, by using corresponding programming stored in a memory as will be well understood by those skilled in the art) to carry out one or more of the steps, actions, and/or functions described herein. In some embodiments, the processing resource 104 cooperates with (e.g., over a network) or incorporates any suitable machine learning models (e.g., neural networks or computer vision models) in order to perform the steps, actions, and/or functions described herein such as accessing the database 106, creating the asset map 118, updating the asset map 118, and creating a displayable map for a servicer and sending the displayable store map to the servicer at the second mobile device 110. The processing resource 104 and/or any additional processing resources may run in parallel with one another such that multiple steps, actions, and/or functions are executed simultaneously. In some embodiments, the processing resource 104 is located at a central location (e.g., at the cloud or a company headquarters to mention a few examples) or spread over or across different locations. In some other aspects, the processing resource 104 is located on a personal computer, laptop, external computing device, etc.

The database 106 is an organized structure of electronic information. The information may be physically stored on machine readable medium such as a random access memory (RAM), read only memory (ROM), electronically erasable programmable read only memory (EEPROM), flash memory, a hard disk drive, or an optical disc to mention a few examples. The database 106 may take on or have any organizational structure (e.g., have a hierarchical, relational, non-relational or object-oriented organization to mention a few examples). The database 106 may also include or incorporate electronic circuitry that is used to access the information stored on the machine readable medium.

The electronic network 108 is any type of electronic communication network or combination of electronic communication networks. For example, the electronic network 108 may be the internet, a cellular network, a wireless network, a local area network, or a wide area network (or a combination of these and other networks) to mention a few examples. Other examples of networks are possible.

As mentioned, the first mobile device 102 includes the transmitter/receiver (TX/RX) 120, magnetic sensor 122, processing resource 124, machine readable medium 126, and sensor 128.

The transmitter/receiver (TX/RX) 120 transmits and receives electronic information to the processing resource 124 via the electronic network 108. The TX/RX 120 may include buffers, converters, and one or more antenna to accomplish these functions. The TX/RX 120 may also accomplish conversion functions such as converting transmitted or received information from one format to another format.

The magnetic sensor 122 may be, in some examples, a magnetometer. Magnetic GPS (mGPS) approaches utilize the Earth's magnetic field to determine the location of an object. In these regards and in some aspects, mGPS approaches measure the magnetic signatures within the indoor facilities using sensors (e.g., magnetometers) to determine the location and orientation of the object (e.g., the first mobile device 102). For example, the magnetometer detects and measures both the Earth's geomagnetic field and the local magnetic anomalies caused by ferromagnetic material (e.g., steel beam or electrical equipment, to mention a few examples) in the indoor facilities. To that effect, the disturbances induced by the various ferromagnetic materials create unique magnetic signatures which are captured and processed to create a magnetic field map (e.g., a geomagnetic fingerprint) of the retail store 114. The magnetic field map may be created and/or updated by the first mobile device 102 as it is used in the store 114 by an employee. Alternatively, another device (or devices) may create the magnetic field map and this magnetic field map is supplied to the first mobile device 102. The magnetic field map may be periodically updated.

As the user travels to a location, raw magnetic data is collected by the magnetic sensor 122 and is processed by one or more algorithms and compared to the magnetic field map to calculate or determine the location of the object. In one example, various matching algorithms are used to match the collected magnetic data to the magnetic field map. In other words, if the magnetic sensor 122 detects a magnetic signature (e.g., the collected magnetic data), and if the magnetic field map recorded the same magnetic signature at a particular location, then the location of the object associated with the magnetic sensor 122 (e.g., the first mobile device 102) is determined to be at that location. Other filter algorithms, error correction algorithms, or algorithms known to those skilled in the art may be used.

MGPS technology provides sub-meter location accuracy and is useful especially within indoor facilities where some location determination approaches are not workable. For example, GPS satellite signals typically cannot penetrate buildings and therefore are not particularly useful in tracking items within buildings. In contrast, mGPS approaches can be used for precise location tracking of objects or items inside indoor facilities such as stores.

It will be appreciated that other types (or combinations) of location determination technologies such as radio based, optical based, or acoustic based technologies may be used instead of mGPS. In some examples, triangulation approaches may be used. In any event, these approaches determine the location of the first mobile device 102 (and hence the asset) to a sub-meter (less than one meter accuracy) and, as mentioned, are especially applicable to finding the locations of devices within indoor facilities such as within retail stores, distribution centers, or warehouses to mention a few examples.

The processing resource 124 of the first mobile device 102 may be configured to execute instructions stored in a machine (or computer)-readable storage memory (e.g., a non-transitory, computer-readable storage medium). Consequently, the processing resource 124 may include a machine readable medium to store electronic instructions as well as a control circuit or controller to execute these instructions.

As with the processing resource 104, the terms control circuit and controller used with respect to the processing resource 124 refer broadly to any microcontroller, computer, or processor-based device with processor, memory, machine readable medium, and/or programmable input/output peripherals, which is generally designed to govern the operation of other components and devices. It is further understood to include common accompanying accessory devices, including memory, a machine readable medium, transceivers for communication with other components and devices to mention a few examples. These architectural options are well known and understood in the art and require no further description here.

The processing resource 124 of the first mobile device 102 may be configured (for example, by using corresponding programming stored in a memory as will be well understood by those skilled in the art) to carry out one or more of the steps, actions, and/or functions at the first mobile device 102 described herein such as receiving information from sensors and determining the location of the first mobile device 102. It will be appreciated, however, that some of these functions may be performed by the processing resource 104. In some embodiments, the processing resource 104 cooperates with (e.g., over a network) or incorporates any suitable machine learning models (e.g., neural networks or computer vision models) in order to perform the steps, actions, and/or functions described herein.

It will be appreciated that the use of the two processing resources 104 and 124 allow parallel processing operations to occur. For example, an employee may be scanning the asset 112 (and processing occurring to determine the location of the asset 112) while, at the same time, the second mobile device 110 is being used by a servicer to locate another asset.

The machine readable medium 126 is any type of memory or medium suitable for storing executable instructions, data, data structures, and/or the asset map 118 such as a random access memory (RAM), a read only memory (ROM), an electronically erasable programmable read only memory (EEPROM), flash memory, a hard disk drive, or an optical disc. Other examples are possible. In some example implementations, the machine readable medium 126 is a non-transitory medium.

The sensor 128 may be any type of sensing arrangement that can obtain sensed information associated with the asset 112. The sensed information may be encoded on a code (e.g., QR code or barcode) or label of the asset and may include information such as the name of the asset, an identification number or other identifier of the asset, when the asset was initially installed, or other operational information concerning the asset 112. For example, the sensor 128 may be an electronic scanner, camera, barcode reader, or other type of sensing arrangement. As shown, the sensor 128 may be incorporated into the mobile device 102. However, in other examples, the sensor 128 may be a physically separate device from the mobile device 102. In this case, the sensor 128 would be communicatively coupled to the mobile device 102.

The second mobile device 110 is any type of mobile electronic communication device. For example, the mobile device 110 may be a smart phone, personal computer, or laptop to mention a few examples. The second mobile device 110 may have the same or similar configuration or structure as the first mobile device 102.

The asset 112 is deployed at the retail store 114. The asset 112 may be a shelf, shelving unit, product (or group of products), refrigerator, freezer, cooler, lighting unit, lighted display, or video display, to mention a few examples. The asset 112 may also be products or groups of products.

The work order 116 is an electronic data structure created automatically or by an employee. The work order 116 describes an asset and describes problems described with the asset. In aspects, the work order 116 includes the coordinates of the asset.

The asset map 118 is any data structure or arrangement that includes or shows assets along with the coordinates of the assets (e.g., within the frame of reference for the indoor facility or potentially in some other frame of reference). The asset map 118 may or may not be in displayable form although it will be appreciated that if the asset map is not in displayable form, then it can be converted into displayable form, for instance by a computer application (app) or similar arrangement. In one form, the asset map 118 is a table listing the assets (by name or other identifier including any alphanumeric type of identifiers) and the locations of each of the listed assets (in coordinates that are in the frame of reference of the indoor facility such as in the frame of reference of the retail store 114). In some aspects, the asset map 118 may be created by the processing resource 104 from coordinates in the work order 116.

One example of the operation of the system of FIG. 1 is now described. An employee of the retail store 114 receives a report of an issue with the asset 112 and takes the first mobile device 102 to the immediate vicinity of the asset 112. By “immediate vicinity” and in some aspects, it is meant that the first mobile device 102 is positioned within about one meter (or less) of the asset 112. In other examples, “immediate vicinity” may be within about three meters (or less) of the asset 112.

At the immediate vicinity of the asset 112, sensor data from the magnetic sensor 122 is obtained by the processing resource 124. The sensor data may be information concerning the strength and/or direction of the earth's magnetic field at the first mobile device 102 and, as such, is associated with the position of the asset 112 within the store 114 since the first mobile device 102 is in the immediate vicinity of the asset 112.

Using the sensor data, the processing resource 124 determines the location coordinates of the first mobile device 102 within the store 114. In aspects, the coordinates are in a global frame of reference such as latitude, longitude, or some other global coordinate system. Location determination may be made, in some examples, using mGPS approaches. Other approaches may also be used.

In one specific example, the processing resource 124 may obtain the sensor data from the magnetic sensor 122 and the sensed data is matched with a predetermined magnetic field map of the retail store 114 to determine a location and orientation of the first mobile device 102. The predetermined magnetic field map may be stored in digital format, for example, in the machine readable medium 126 or in the database 106. Once the processing resource 124 identifies the location of the first mobile device 102 on the magnetic field map, the processing resource 124 may determine and assign the coordinates of the location of the first mobile device 102.

Identification information associated with the asset is also received. In one example, the information is obtained by the sensor 128. In other examples, the employee may manually enter the information.

The initiation of determining the location of the first mobile device 102 may be accomplished in a variety of different ways. For example, the employee may press a button or other actuator on the screen of the first mobile device 102 to cause the processing resource 124 to obtain data from the magnetic sensor 122. In these regards, the processing resource 124 may send a control signal to the magnetic sensor 122 indicating the desire of the processing resource 124 to receive magnetic data from the magnetic sensor 122. In aspects, this signal may actuate the magnetic sensor 122.

In another example, the employee using the first mobile device 102 may scan a code from the asset 112 and the act of scanning causes an electronic control signal to be sent from the processing resource 124 to the magnetic sensor 122 indicating the desire of the processing resource 124 to receive magnetic data from the magnetic sensor 122. In aspects, this signal may actuate the magnetic sensor 122.

In still other examples, the processing resource 124 automatically and periodically sends control signals to the magnetic sensor 122 indicating the desire of the processing resource 124 to receive magnetic data from the magnetic sensor 122. In this case, the magnetic sensor 122 automatically responds. In aspects, these control signals may actuate the magnetic sensor 122.

The coordinates are converted by the processing resource 124 from the global frame of reference to a frame of reference of the indoor facility. In aspects, the frame of reference of the indoor facility is different and unique from the global frame of reference. Conversion may be accomplished using any suitable techniques such as by using appropriate equations or using a mapping table that utilizes a known mapping relationship to map the global coordinates to coordinates of the retail store 114. In one example, the coordinates of the retail store may be cartesian (x, y, z) coordinates with an origin at some location (e.g., corner) of the store 114. For example, the origin may be at (0, 0, 0). Other coordinates may be in some known measurement units. For example, a freezer may be at (150.2, 50.7, 0) and these coordinate numbers are in meters.

The converted coordinates and the associated identification information are attached, incorporated, linked or otherwise associated with the work order 116, and the work order 116 is stored in the database 106. For example, the work order 116 may be created by the processing resource 124 of the first mobile device 102, transmitted using the TX/RX 120 of the first mobile device 102 to the electronic network 108, and received at the processing resource 104. Alternatively, only the coordinates of the first mobile device 102 may be transmitted and the work order 116 transmitted separately. The processing resource 104 stores the work order 116 in the database 106.

The asset map 118 is created and stored in the database 106 by the processing resource 104 and is updated with the converted coordinates of the asset 112, which in examples, are in the work order 116 received from the first mobile device 102. In some aspects, the asset map 118 represents a digital twin of the store 114. Subsequently, the asset map 118 is accessed and used by a servicer via the second mobile device 110 to locate and navigate to the asset 112 without involvement of employees or resources of the store 114 allowing an adjustment or a servicer to occur.

In some examples and at the mobile device 102, the employee may be shown the location (on a screen or display of the first mobile device 102) automatically determined by the processing resource 124 using the sensed data (e.g., magnetic data) received from the magnetic sensor 122. For example, the employee may be shown a screen on the first mobile device 102 with a map of the store 114 and a point on the map (e.g., a highlighted point in a predetermined color) of where the automatically determined location is within the store. However, the employee may not be satisfied with the automatically determined location believing this location to be incorrect. Consequently, the employee can override the automatically determined location and, for instance, move a digital pin to the location on the store map (displayed on the screen) to represent the true location of the asset 112. The pinned location is then used in the work order (and stored in the asset map 118) instead of the automatically determined location.

When a robot rather than an employee (or with the employee) is used to go to the asset 112, the robot can use sensors to check whether the location observed is likely to be the true location of the asset 112 or whether this asset location should be changed in the work order 116. For example, a robot can obtain images from cameras and determine whether these images show the asset 112 or the correct visual context of the asset. For example, if the asset 112 is a freezer for storing frozen vegetables, the images can be analyzed (e.g., by a machine learning algorithms or approaches) to determine if the asset 112 is in the images and, if so, other items, appliances, products or fixtures that would be expected to be found in the frozen food section of a store are present in the image.

Once the servicer arrives at the location the asset 112, various actions can be performed. In some examples, the asset 112 may be repaired. For example, defective parts can be removed from the asset 112 and the repaired parts or new parts inserted into the asset 112. If the asset 112 is a presentation or display structure, elements of the structure (or the entire structure) can be moved. For example, a shelving or display unit may be moved or shelves within a shelving unit may be adjusted or moved.

Once the servicer is finished with servicing the asset 112, they can move to another asset. In these regards, they may use the second mobile device 110 to contact the processing resource 104 for the next asset to service. The processing resource 104 may create and send the servicer a store map showing the location of the next asset. This new store map is different from the first store map they received because it will show the current location of the servicer at the asset 112 and the route to the next asset to service. This new route will be the most efficient or effective route to reach the next asset to service from the asset 112. Consequently, a series of store maps with asset locations may be created and sent from the processing resource 104 to the second mobile device 110 with each of these maps depending upon a current location of the servicer.

Alternatively, the processing resource 104 may send a single store map showing all assets to service to the servicer. This single store map will show how the servicer can reach the asset 112 and from the asset 112 all remaining assets. In examples, the store maps sent may include written or textual instructions of how to reach the various assets (e.g., “From the entrance, turn right at the checkout area, continue 100 meters, and turn left and reach the second aisle . . . ”). The written or textual instructions may also include distance to the asset, estimated time of arrival and various points of interest along the route to the asset. In other examples, the store maps sent may include arrows or other visual instructions to guide the servicer to the asset 112 and form the asset 112 to all the remaining assets.

Advantageoudly, the approaches presented herein allow for servicers to be guided to and service assets in indoor facilities in a quick and efficient manner. These approaches avoid contacting store employees or using other valuable store resources. These approaches also offer specific technical advantages over previous approaches such as the automatic and accurate determination of asset locations in real time, leading to faster repair or servicing of assets, and more efficient store operation. These technical advantages may be achieved at least in part by using parallel processing resources (e.g., one processing resource at the employee mobile device, another processing resource at a central location, and/or another processing resource at the mobile device of the servicer to mention one example). The use of specific location determination technologies such as mGPS also provides specific technical advantages of providing sub-meter accuracy for asset locations. Further technical advantages (e.g., the efficient use of electronic resources) can be provided by the control of various sensors (e.g., the control of mGPS sensors) as has been described elsewhere herein.

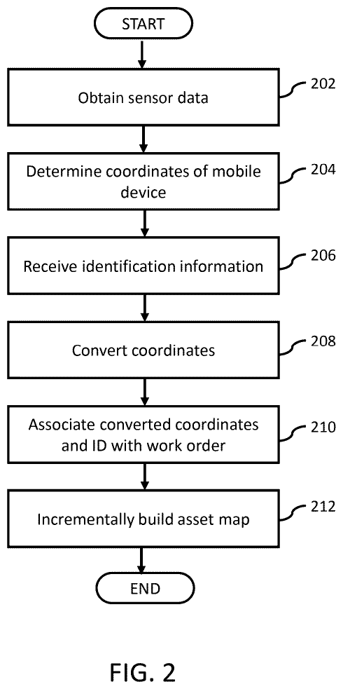

Referring now to FIG. 2, one example of an approach for determining and using asset locations is described. In accordance with some embodiments, the method of FIG. 2 may be performed by any of the systems described herein, such as the system of FIG. 1, and/or other systems. At step 202, sensor data is obtained from a sensor that is associated with a mobile device that is positioned in an immediate vicinity of an asset of an indoor facility. In examples, the sensor data is magnetic data received from a magnetometer. The sensor may be incorporated in a mobile device.

At step 204, using the sensor data, location coordinates of the mobile device are determined within the indoor facility. The coordinates are in a global frame of reference.

At step 206, identification information of the asset is obtained. The identification information may include the name, part number, or other identifier of the asset. Other examples of identification information are possible.

At step 208, the coordinates determined at step 204 are converted from the global frame of reference to a frame of reference of the indoor facility. For example, the coordinates may be in the form of a longitude, latitude and need to be converted to the frame of reference of the retail store. In one form, the coordinates may be cartesian coordinates but can be also in polar (or other) forms. It will be appreciated that the coordinates, in some examples, are in three dimensions. For example, (x, y) coordinates may indicate a particular shelving unit, but a z coordinate may indicate a particular shelf within the shelving unit. In other aspects, product (or groups of products) can have their locations determined and utilized.

At step 210, the converted coordinates and the associated identification information are incorporated to a work order associated with the asset, the work order stored in a database. As describe herein, an asset map in a database can then be updated with the converted coordinates of the asset with the asset map representing a digital twin of the indoor facility. Updating may include creating the asset map, including a new asset and its coordinates into an existing asset map, and/or changing the coordinates of an asset already in the asset map. Assets (and their coordinates) can also be removed from the asset map (e.g., if the asset is decommissioned and removed from the store).

At step 212, the asset map is incrementally updated and built over time. That is, the asset map may be initially empty and change as assets are added or deleted. It will also be appreciated that assets can be moved and as this occurs and new issues or problems are identified with respect to these assets, the employee goes to these assets, scans the asset, and a new work order is created. New coordinates of the asset will be determined as the employee moves their mobile device to the general vicinity of the asset. In one example, general vicinity means one meter or less, in another example, general vicinity means three meters or less. Other examples are possible.

Subsequently, the asset map is accessed and used by a servicer to locate and navigate to the asset without involvement of employees or resources of the indoor facility allowing an adjustment or a servicing of the asset by the servicer to occur. For example, the asset can be repaired, moved, or otherwise adjusted.

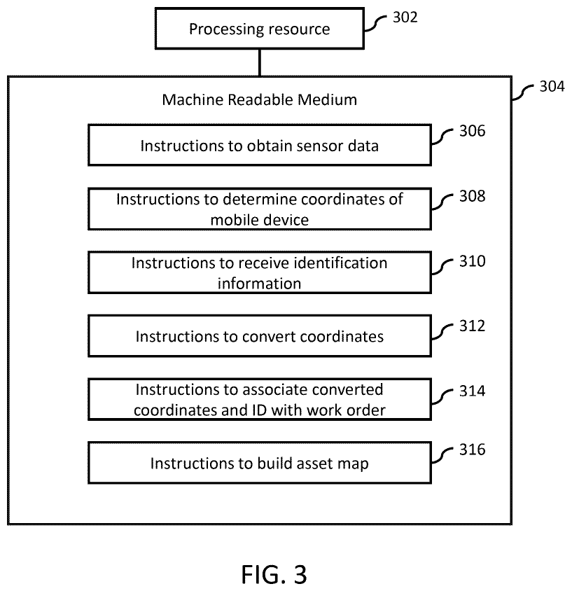

Referring now to FIG. 3, one example of a non-transitory machine readable medium 304 storing instructions that, when executed, cause a processing resource 302 to perform various actions or functions is described. The processing resource 302 executes the instructions on the machine readable medium 304. It should be understood that part or all of the executable instructions and/or electronic circuits included within one box of FIG. 3 may, in alternate implementations, be included in a different box shown in the figures or in a different box not shown. Some implementations may include more or fewer instructions than are shown in FIG. 3.

More specifically, the machine readable medium 304 may be any medium suitable for storing executable instructions, such as RAM, ROM, EEPROM, flash memory, a hard disk drive, an optical disc, or the like. The machine readable medium 304 may be the machine readable medium 126 of the first mobile device 102 and the processing resource may be processing resource 124 of the first mobile device 102. In addition or alternatively, the machine readable medium 304 may be located in or associated with the processing resource 104 of FIG. 1.

As described below, the machine readable medium 304 may be encoded with a set of executable electronic instructions 306, 308, 310, 312, 314, and 316. At least some of these instructions may be executed when a mobile device (e.g., the first mobile device 102) is in the immediate vicinity of an asset. In some aspects, instructions 306, 308, 310, 312, 314 may be executed at a processing resource at a mobile device (e.g., the processing resource 124 at the first mobile device 102).

Instructions 306, when executed, cause sensor data to be obtained from the sensor associated with the mobile device (e.g., the first mobile device 102). For example, these instructions may obtain or receive magnetic sensor measurements or data from the magnetic sensor 122. In some aspects, the data may include a location of the mobile device (e.g., the first mobile device 102) on a magnetic field map.

Instructions 308, when executed, determine, using the sensor data, location coordinates of the mobile device within the indoor facility. The coordinates are in a global frame of reference such as in latitude and longitude format. For example, algorithms stored at the machine readable medium 304 are executed by these instructions to determine a location that is indicated by the data or measurements received from the sensor (e.g., the magnetic sensor 122). Instructions 308 may be caused to be executed based upon an employee actuating a button or other actuator on the first mobile device 102. Alternatively, instructions 308 may be executed upon or after execution of instructions 310. In still another approach, the instructions 308 are executed periodically to periodically sample data from the sensor (e.g., the magnetic sensor 122). The instructions 308 may be executed automatically.

Instructions 310, when executed, receive or obtain identification information associated with the asset. For example, and referring to the system 100 of FIG. 1, the sensor 128 of the first mobile device 102 is actuated to scan a label or code on the asset 112. The scanned information may indicate the name of the asset, the type of asset, or other characteristics of the asset. Instructions 310 may be caused to be executed upon receiving an indication of the employee.

Instructions 312, when executed, convert the coordinates from the global frame of reference to a frame of reference of the indoor facility. For example, the coordinates may be converted to cartesian coordinates from a first frame of reference (a global frame of reference). Various equations or mappings can be used as known to those skilled in the art.

Instructions 314, when executed, associate the converted coordinates and the associated identification information with a work order associated with the asset. The work order can then be stored in a database.

Instructions 316, when executed update the asset map. For example, an entry in an asset map may be created. If the asset and its location are already in the asset map, this entry may be changed to reflect an updated (new) location. Instructions 316 in one example may be executed at a centrally located processing resource (e.g., the processing resource 104).

Subsequently, the asset map is accessed and used by a servicer to locate and navigate to the asset without involvement of employees or resources of the indoor facility allowing an adjustment or a servicing of the asset by the servicer to occur.

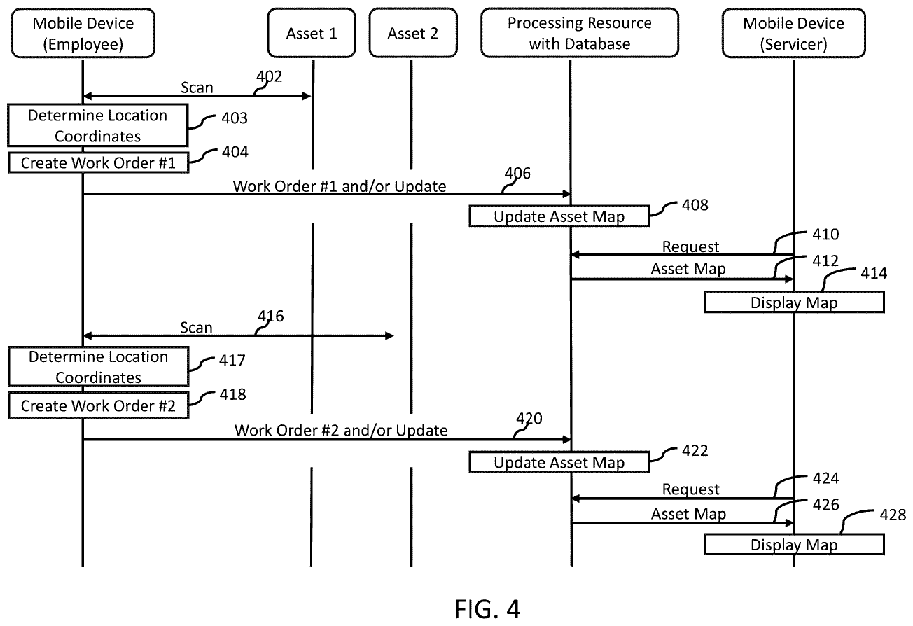

Referring now to FIG. 4, a flow diagram shows an approach for determining, tracking, and using asset locations. The system includes a first asset, a second asset, a processing resource with a database, a mobile device (used by a store employee), and a mobile device (used by a servicer). In the example of FIG. 4, the assets are within an indoor facility, which is a retail store. In accordance with some embodiments, the process of FIG. 4 may be performed by any of the systems or devices described herein and/or other systems.

At step 402, the mobile device (of the store employee) scans the first asset. The scan may be of a code or a label on the first asset. The code or label indicates information about the asset, for example, the name of the asset, the type of asset, or other operational information concerning the first asset.

At step 403, the location of the mobile device is determined with respect to the first asset. For example, the mobile device (of the store employee) may be equipped with one or more magnetic GPS (mGPS) sensors to determine the location of the mobile device (of the store employee). Other location determination technologies can also be used. Initiation of step 403 may be automatically caused by the execution or completion of step 402 or may be independently caused, for example, by an employee actuating a button or other actuator on the mobile device (of the store employee).

At step 404, a first work order (work order #1) is created at the mobile device (of the employee). The work order may include or have associated the coordinates that are in the frame of reference of an indoor facility such as a retail store. These coordinates may be converted from the raw coordinates determined at step 403.

At step 406, work order #1 and/or the coordinates of the asset are sent from the mobile device (of the employee) to the processing resource/database. The processing resource/database may be centrally located (e.g., at the cloud, a company headquarters, or come other central location).

At step 408, the asset map is updated. In this step, the asset map is updated by the centrally located processing resource. For example, if the asset map does not already exist then the processing resource may create the asset map. In some embodiments, by “asset map,” it is meant any data structure that includes or shows asset coordinates. The asset map may or may not be in displayable form although it will be appreciated that if the asset map is not in displayable form, then it can be converted to displayable form, for instance by a computer app. In one form, the asset map is a table listing the assets (by name or other identifier including any alphanumeric type of identifiers) and the location of the asset (in coordinates that are in the frame of reference of the indoor facility such as in the frame of reference of the retail store). Other data structures may be used for the asset map.

At step 410 and subsequently, a servicer sends a request for the asset map (or information indicating an asset's location, which is included in the asset map). For example, the servicer may be a technician that sends a request to the processing resource for information concerning the first asset. The request may include the name or other identifier that relates to the asset and may be made from the mobile device of the servicer.

At step 412, the processing resource/database responds to the request from the servicer with the asset map (or information indicating an asset's location, which is included in the asset map). This response may include the entire asset map, coordinates of the first asset from the asset map, and/or an actual store map showing the location of the asset within the store. In these regards, the centrally located processing resource may create a displayable map of the indoor facility (e.g., the store) with the location of the first asset highlighted or otherwise indicated on the displayable map. In some other examples and where only the coordinates are sent in the response, the mobile device (of the servicer) may create a displayable store map visually showing the location of the first asset within the context of the store.

At step 414, the displayable map is rendered or presented to the servicer. If only the coordinates are sent by the processing resource, then these coordinates can be used or included in a displayable map of the indoor facility by the mobile device (of the servicer). Then, this map can be displayed. On the other hand, if the central processing resource created a map, then this map can be directly displayed at the mobile device (of the servicer).

At step 416. the mobile device (of the employee) scans the second asset. In aspects, the same (or a different) store employee goes through the indoor facility (e.g., retail store) to a second asset where the second asset is different than the first asset. For example, the first asset may be a freezer and the second asset may be a heated enclosure where both assets are used to store and present perishable food items to customers. In aspects, the second aspect may be the same as the first asset. For example, the first asset may be a condenser of a freezer and the second asset may be a thermostat of the freezer.

At step 417, the location of the mobile device (of the store employee) is determined. As before, the mobile device (of the store employee) may be equipped with one or more magnetic GPS (mGPS) sensors to determine the location of the mobile device (of the store employee). Other location determination technologies can also be used. Initiation of step 417 may be automatically caused by the execution or completion of step 402 or may be independently caused, for example, by an employee actuating a button or other actuator on the mobile device.

At step 418, a second work order (work order #2) is created. The second work order may include or have associated the coordinates of the second asset that are in the frame of reference of an indoor facility such as a retail store. The raw coordinates determined at step 417 may be converted from a global frame of reference to the frame of reference of the indoor facility.

At step 420, work order #2and/or a location update (coordinates of the asset) are sent from the mobile device (of the employee) to the processing resource/database. As mentioned, the processing resource/database may be centrally located (e.g., at the cloud, a company headquarters, or come other central location).

At step 422, the asset map is updated. In this example, the asset map already exists. As mentioned before, the asset map may or may not be in displayable form although it will be appreciated that if the asset map is not in displayable form, then it can be converted to displayable form, for instance by a computer application (app) at the mobile device of the servicer. In one form and as mentioned, the asset map is a table listing the assets (by name or other identifier including any alphanumeric type of identifiers) and the location of the asset (in coordinates that are in the frame of reference of the indoor facility such as in the frame of reference of the retail store). In case, the asset map may be updated to include the coordinates of the second asset (if the second asset is not already in the asset map) or to update the coordinates of the second asset (if the second asset already is in the asset map and already has coordinates in the asset map).

At step 424 and subsequently, the servicer sends a request for the asset map (or information indicating an asset's location, which is included in the asset map). For example, the servicer may be a technician that sends a request to the processing resource for information concerning the second asset. The request may include the name or other identifier that relates to the second asset.

At step 426, the centrally located processing resource/database responds with the asset map(or information indicating an asset's location, which is included in the asset map). This response may include the entire asset map, coordinates of the first asset from the asset map, and/or an actual store map showing the location of the asset within the store. In these regards, the centrally located processing resource may create a displayable map of the indoor facility (e.g., the store) with the location of the second asset highlighted or otherwise indicated on the displayable map. In some other examples and where only the coordinates are sent in the response, the mobile device (of the servicer) may create a displayable store map visually showing the location of the second asset within the context of the store.

At step 428, the map is displayed at the servicer. If only the coordinates are sent by the processing resource, then these coordinates can be used or included in a displayable map of the indoor facility by the mobile device (of the servicer). Then, this map can be displayed. On the other hand, if the central processing resource created a map, then this map can be directly displayed at the mobile device (of the servicer).

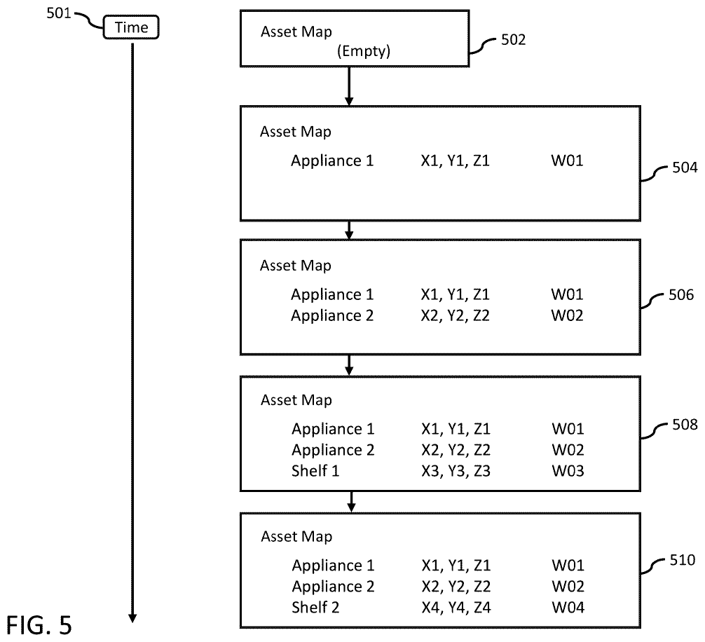

Referring now to FIG. 5, one example of an asset map and how it dynamically changes according to these approaches in accordance with some embodiments. Time 501 is generally progressing as the steps are executed.

At step 502, the asset map is initially empty. In other aspects, the asset map does not exist and will need to be created upon a creation of a first work order from an employee.

At step 504, the asset map is shown after a first update has been performed. A first asset (Appliance 1) with coordinates (x1, y1, z1) has an associated first work order (WO1). The WO1 may be a link to another file that is the first work order (WO1). In this case, an employee has gone to the vicinity of the first asset (Appliance 1), has scanned information from the first asset (Appliance 1), and a location of the mobile device of the employee has been determined when the employee (and their mobile device) was in the immediate vicinity of the first asset (Appliance 1). The first work order (WO1) was also created. This location information of the first asset (Appliance 1) is included in the asset map as shown at step 504.

At step 506, the asset map is shown after a second update. An Appliance 2 with coordinates (x2, y2, z2) has an associated second work order (WO2). The WO2 may be or include a link to another file that is the second work order (WO2). In this case, an employee has travelled to the immediate vicinity of the second asset (Appliance 2), has scanned information from the first asset (Appliance 2), and a location of the mobile device of the employee has been determined. As discussed, these actions occurred when the employee (and their mobile device) were in the immediate vicinity of the first asset (Appliance 2) creating the second work order (WO2). The location information of the second asset (Appliance 2) was included in the asset map shown at step 506.

At step 508, the asset map is shown after a third update. A third asset (Shelf 1) with coordinates (x3, y3, z3) has an associated third work order (WO3). The WO3 may be a link to another file that is the third work order (WO3). In this case, an employee has gone to the vicinity of the third asset (Shelf 1), has scanned information from the third asset (Shelf 1), and a location of the mobile device of the employee has been determined when the employee (and their mobile device) was in the immediate vicinity of the third asset (Shelf 1). The third work order (WO3) was also created. This location information of the third asset (Shelf 1) is included in the asset map as shown at step 508.

At step 510, the asset map is shown after a fourth update. The coordinates of Shelf 1 have been changed from (x3, y3, z3) to (x4, y4, Z4). This update has an associated fourth work order (WO4). This is the result of the employee going back and, in this example, moving the shelf to a different location and creating the fourth work order.

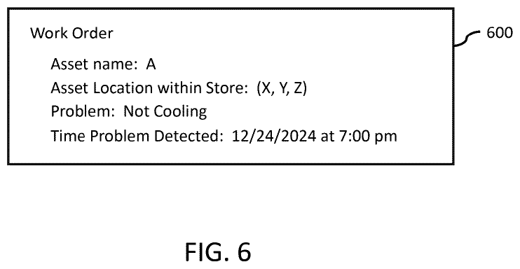

Referring now to FIG. 6, one example of a work order 600 is described. As shown in FIG. 6, the work order 600 includes an asset name, an asset location within the store (in x, y, z coordinates), a problem (e.g., associated with the asset, for example, the asset is not cooling or heating properly), and a time the work order was created. Other information can also be included in the work order 600.

In examples, the work order 600 can be created by a mobile device (e.g., the first mobile device 102). In other examples, the work order 600 may be created by a centrally located processing resource (e.g., processing resource 104). The asset location information of the work order is, in aspects, used or included in the asset map and this occurs at or shortly after the creation of the work order 600. In this way, creation of the asset map is tied to the creation of the work order and is automatically accomplished.

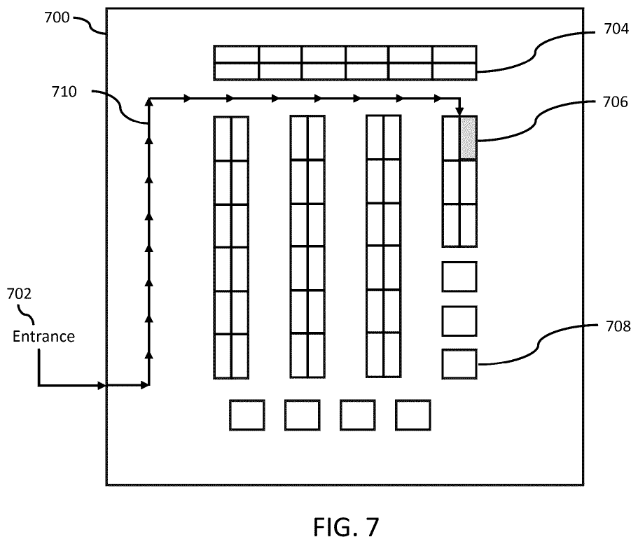

Referring now to FIG. 7, one example of a displayable map 700 that can be created and displayed to a servicer is described. The map 700 can, for example, be displayed on the mobile device of the servicer. The map 700 is created from the asset map (information in the asset map) and a template of the store (the template including, for example, overall dimensions of the store, the positioning and fixed structures such as shelving units, cash registers and backrooms to mention a few examples). The map 700 may be created at the central processing resource or by an app at the mobile device of the servicer (e.g., technician) to mention a few examples.

In the example of FIG. 7, the displayable map 700 shows the path to only one asset-to-be serviced 706. However, it will be appreciated that the displayable map 700 can also include paths to other assets. For example, the displayable map 700 could show a path to a first asset, from the first asset to a second asset, and from the second asset to a third asset. Alternatively, a series of displayable maps may be created, for example, a first showing a path from the entrance of the store to a first asset, a second displayable map from the first asset to ta second asset, and a third displayable map from the second asset to a third asset. It will also be appreciated that written or audio instructions (in addition to or in place of the displayable map 700) may also be included or used.

The displayable map 700 shows store fixtures (appliances, shelves, or other machines or structures) 704. Moveable shelving units 708 are shown on the displayable map 700. The asset to-be-serviced 706 is also shown on the displayable map 700. An entrance to the store 702 is also shown and a path 710 from the entrance to the asset-to-be-serviced 706 is shown.

As mentioned, the displayable map 700 may all be created at the mobile device of the servicer (e.g., the second mobile device 110) or at a central location (e.g., by the processing resource 104) and sent to the servicer.

The path 710 from the entrance to the store 702 to the asset-to-be-serviced 706 may be the shortest path, the most efficient path based on the time of day, the path with the least obstacles and so forth. Other examples of criteria can also be selected to choose the path 710. The mobile device of the servicer may execute an algorithm that evaluates the above-mentioned factors to optimize the path 710. In addition, such an algorithm may allow the servicer to input their personal preferences or rank the criteria to use (e.g., the shortest path is the most important).

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A system comprising:
a database; and
a mobile device comprising:
a processing resource communicatively coupled to the database via an electronic network;
a magnetic sensor coupled to the processing resource; and
a machine readable medium coupled to the processing resource and storing instructions that, where executed by the processing resource and when the mobile device has been brought to within three meters or less of an asset of an indoor facility because of an identified operational problem at the asset, cause the processing resource to:
responsive to the mobile device being within three meters or less of the asset of the indoor facility and responsive to a creation of an electronic work order, selectively transmit an electronic control signal to the sensor to actuate the magnetic sensor and obtain sensor data from the magnetic sensor, the sensor data comprising magnetic field measurements from the magnetic sensor, the work order comprising an electronic data structure describing the asset and the identified operational problem associated with the asset;
determine, by correlating the sensor data to a stored magnetic field map of the indoor facility, location coordinates with sub-meter accuracy of the mobile device within the indoor facility, the location coordinates being in a global frame of reference;
receive identification information associated with the asset;
convert the coordinates from the global frame of reference to converted coordinates in a frame of reference of the indoor facility; and
associate the converted coordinates and the associated identification information with the work order associated with the asset, the work order stored in the database, and wherein an asset map in the database for the indoor facility is updated with the converted coordinates of the asset, the asset map representing a digital twin of the indoor facility.

2. The system of claim 1, wherein, subsequently, the asset map is accessed and used by a servicer to locate and navigate to the asset without involvement of employees or resources of the indoor facility allowing an adjustment or a servicing of the asset by the servicer to occur.

3. The system of claim 1, wherein the identification information is obtained by scanning a code on the asset.

4. The system of claim 1, wherein the identification information comprises a name of the asset.

5. The system of claim 1, wherein the asset comprises a store appliance or a store fixture.

6. The system of claim 1, wherein the mobile device determines the location coordinates by sensing a magnetic location of the mobile device using the sensor.

7. The system of claim 1, wherein the mobile device is brought to the asset by a store employee.

8. The system of claim 1, wherein the converted coordinates of the asset are dynamically updated over time based upon subsequent work orders.

9. A method comprising:
in response to a mobile device being positioned within three meters or less of an asset of an indoor facility, creating an electronic work order to address an identified operational problem with the asset, the work order comprising an electronic data structure describing the asset and the identified operational problem associated with the asset;
upon creation of the electronic work order, transmitting an electronic control signal to a magnetic sensor, the electronic control signal being effective to actuate the magnetic sensor;
when actuated, obtaining sensor data from the magnetic sensor that is associated with a mobile device that is positioned within three meters or less of an asset of an indoor facility the sensor data comprising magnetic field measurements from the magnetic sensor,
determining, by correlating the sensor data to a stored magnetic field map of the indoor facility, location coordinates with sub-meter accuracy of the mobile device within the indoor facility, the location coordinates being in a global frame of reference;
receiving identification information associated with the asset;
converting the location coordinates from the global frame of reference to converted coordinates in a frame of reference of the indoor facility; and
associating the converted coordinates and the associated identification information with a work order associated with the asset, the work order stored in a database, and wherein an asset map in the database for the indoor facility is updated with the converted coordinates of the asset, the asset map representing a digital twin of the indoor facility.

10. The method of claim 9, wherein, subsequently, the asset map is accessed and used by a servicer to locate and navigate to the asset without involvement of employees or resources of the indoor facility allowing an adjustment or a servicing of the asset by the servicer to occur.

11. The method of claim 9, wherein the identification information is obtained by scanning a code on the asset.

12. The method of claim 9, wherein the identification information comprises a name of the asset.

13. The method of claim 9, wherein the asset comprises a store appliance or a store fixture.

14. The method of claim 9, wherein determining the location coordinates comprises the mobile device sensing a magnetic location of the mobile device using the sensor.

15. The method of claim 9, wherein the mobile device is brought to the asset by a store employee.

16. The method of claim 9, wherein the converted coordinates of the asset are dynamically updated over time based upon subsequent work orders.

17. A non-transitory machine readable medium storing instructions that, when executed, cause a processing resource to:
in response to a mobile device being positioned within three meters or less of an asset of an indoor facility:
create an electronic work order, the electronic work order comprising an electronic data structure describing the asset and an identified operational problem associated with the asset;
responsively transmit an electronic control signal to a magnetic sensor, the electronic control signal being effective to actuate the magnetic sensor;
obtain sensor data from the magnetic sensor associated with the mobile device the sensor data comprising magnetic field measurements from the magnetic sensor,
determine, by correlating the sensor data to a stored magnetic field map of the indoor facility, location coordinates with sub-meter accuracy of the mobile device within the indoor facility, the location coordinates being in a global frame of reference;
receive identification information associated with the asset;
convert the coordinates from the global frame of reference to converted coordinates in a frame of reference of the indoor facility;
associate the converted coordinates and the associated identification information with a work order associated with the asset, the work order stored in a database; and
updating an asset map in the database for the indoor facility with the converted coordinates of the asset, the asset map representing a digital twin of the indoor facility.

18. The non-transitory machine readable medium of claim 17, wherein, subsequently, the asset map is accessed and used by a servicer to locate and navigate to the asset without involvement of employees or resources of the indoor facility allowing an adjustment or a servicing of the asset by the servicer to occur.

19. The non-transitory machine readable medium of claim 17, wherein the identification information is obtained by using the mobile device to scan a code on the asset.

20. The non-transitory machine readable medium of claim 17, wherein the identification information comprises a name of the asset.
